(19) United States
(12) Patent Application Publication
(10) Pub. No.: US 2026/0112688 A1
(43) Pub. Date: Apr. 23, 2026

(54) HIGH YOUNG'S MODULUS SOLID ELECTROLYTE, ALL-SOLID-STATE LITHIUM BATTERY, AND PREPARATION METHODS THEREOF

(71) Applicant: GRINM (Guangdong) Institute for Advanced Materials and Technology, Foshan (CN)

(72) Inventors: Jianwen LIANG, Foshan (CN); Xu HAN, Foshan (CN); Xiaona LI, Foshan (CN); Changtai ZHAO, Foshan (CN); Xueliang SUN, Foshan (CN)

(21) Appl. No.: 19/203,140

(22) Filed: May 8, 2025

(30) Foreign Application Priority Data
Oct. 18, 2024 (CN) 202411460569.6

(51) Int. Cl. H01M 10/0562; H01M 10/052

(52) U.S. Cl. CPC H01M 10/0562; H01M 10/052; H01M 2300/008

(57) ABSTRACT

Disclosed are a high Young's modulus solid electrolyte, an all-solid-state lithium battery, and preparation methods thereof, belonging to the technical field of batteries. The preparation method of the high Young's modulus solid electrolyte includes following steps: firstly, melting an electrolyte raw material under dry and oxygen-free conditions, then rapidly cooling into a solid block, and grinding into powder. The process is simple, and the prepared solid electrolyte has good mechanical properties. According to the all-solid-state lithium battery prepared from the solid electrolyte, the interface stability of the lithium battery can be greatly improved, the solid-solid mechanical contact is improved, and the cycle performance and efficiency of the battery are improved.

### CROSS-REFERENCE TO RELATED APPLICATIONS

This application claims priority to Chinese Patent Application No. 202411460569.6, filed on Oct. 18, 2024, which is incorporated herein by reference in its entirety.

### TECHNICAL FIELD

The present disclosure belongs to the technical field of batteries, and particularly relates to a high Young's modulus solid electrolyte, an all-solid-state lithium battery, and preparation methods thereof.

### BACKGROUND

Solid-state lithium-ion batteries have become a current research hotspot and future research trend due to their advantages such as high safety, high energy density, and cycle performance. However, compared with liquid lithium-ion batteries, solid-state batteries have contact problems between solids, which will lead to low lithium ion transmission efficiency, chemical reactions occurring at the interface, and mechanical stress problems. In addition, the stability of the solid-solid interface will seriously affect the electrochemical performance and safety of the battery, which also hinders the practical application of solid-state batteries.

At present, most of the research on the interface problems of solid-state batteries focuses on chemical reactions. However, unfavorable electrochemical-mechanical dynamics may lead to poor material utilization, mechanical degradation and poor ion transport, thus affecting the performance and life of the battery. Mechanical properties are important physical properties of solid materials, and the mechanical behaviors exhibited by the solid materials have a significant impact on the mechanical stability and electrochemical performance of solid-state batteries. Therefore, it is of great significance to study the material mechanical properties of various components of solid-state batteries and the resulting mechanical failure behaviors. Because a solid electrolyte is in direct contact with positive and negative electrodes, its mechanical properties have a significant impact on the mechanical integrity of the positive and negative electrodes, and the mechanical stability of solid-state lithium batteries largely depends on the mechanical properties of the solid electrolyte. Therefore, how to develop an electrolyte that can improve the physical and mechanical stability of solid-state batteries and release the structural stress accumulated during the cycle is a technical problem needing to be urgently solved by those skilled in the art. At present, most strategies to improve the mechanical properties of solid electrolytes include: regulating their own phase composition, grain size, porosity, and the like, or reducing the defects of the electrolytes by doping and adding other components to the electrolytes, so as to improve their performance. However, the preparation processes of these regulation methods are relatively complicated and difficult in variable control.

### SUMMARY

One object of the embodiments of the present disclosure is to provide a preparation method of a high Young's modulus solid electrolyte, which is simple in process and produces a solid electrolyte with good mechanical properties.

Another object of the embodiments of the present disclosure is to provide a preparation method of an all-solid-state lithium battery, which is simple in process and produces an all-solid-state lithium battery with good electrochemical performance and long service life.

The embodiments of the present disclosure are implemented as follows:

An embodiment of the present disclosure provides a preparation method of a high Young's modulus solid electrolyte, including following steps:
S1: melting an electrolyte raw material under dry and oxygen-free conditions, with a melting temperature of 405-700° C. and a melting time of 1-20 h;
S2: rapidly cooling the molten liquid electrolyte into a solid block, with a cooling rate controlled at 600-1200° C./min; and
S3: grinding the cooled solid block into powder to prepare a high Young's modulus solid electrolyte.

Further, in step S1, the melting temperature is 405° C. and the melting time is 20 h, or the melting temperature is 500° C. and the melting time is 15 h, or the melting temperature is 600° C. and the melting time is 10 h, or the melting temperature is 700° C. and the melting time is 1 h.

Further, in step S2, the cooling rate is 600° C./min, 800° C./min, 1000° C./min or 1200° C./min.

Further, the electrolyte raw material is Li₂₊ₓMₓN₁₋ₓCl₆, where M is one or more of Y, Er, Yb, Ho, In, La, Sc, Tb, and Dy; N is one or two of Zr and Hf; and 0≤x≤1.

Further, the electrolyte raw material is Li_{2.5}Y_{0.5}Zr_{0.5}Cl₆, Li_{2.6}Y_{0.6}Hf_{0.4}Cl₆, Li₃YCl₆ or Li_{2.5}Yb_{0.5}Hf_{0.5}Cl₆.

An embodiment of the present disclosure further provides a high Young's modulus solid electrolyte, which is obtained by the above-mentioned preparation method of the solid electrolyte.

An embodiment of the present disclosure further provides an all-solid-state lithium battery, including a positive electrode active material layer, a negative electrode active material layer, and the high Young's modulus solid electrolyte, where the high Young's modulus solid electrolyte is pressed into a block and is disposed between the positive electrode active material layer and the negative electrode active material layer.

An embodiment of the present disclosure further provides a preparation method of the all-solid-state lithium battery, including following steps:
A1: mixing a layered cathode material with the high Young's modulus solid electrolyte in a mass ratio of 7:3, and then grinding the resulting mixture into powder to obtain a cathode powder;
A2: weighing an appropriate amount of sulfide solid electrolyte and placing the sulfide solid electrolyte into a liner of a mold battery; applying a pressure of 100 MPa for tabletting to obtain a first electrolyte layer; then, taking an appropriate amount of the high Young's modulus solid electrolyte and evenly placing the high Young's modulus solid electrolyte onto the side of the first electrolyte layer in a thickness direction; applying a pressure of 150 MPa for tabletting to obtain a second electrolyte layer;
A3: placing the cathode powder evenly on the side of the second electrolyte layer away from the first electrolyte layer, and applying a pressure of 350 MPa for tabletting to obtain a positive electrode active material layer;
A4: placing a metal indium sheet on the side of the first electrolyte layer away from the second electrolyte layer, and applying a pressure of 50 MPa for tabletting to obtain a negative electrode active material layer; and
A5: placing the liner into the mold battery, locking and sealing to make an all-solid-state lithium battery.

The present disclosure has the following beneficial effects:
(1) The preparation method of the electrolyte provided by the embodiment of the present disclosure is simple in process. The solid electrolyte prepared by rapid cooling has higher Young's modulus and better mechanical properties.
(2) According to the all-solid-state lithium battery provided by the embodiment of the present disclosure, the interface stability of the lithium battery can be significantly improved, the solid-solid mechanical contact is improved, and the cycle performance and efficiency of the battery are improved.

### BRIEF DESCRIPTION OF THE DRAWINGS

In order to more clearly illustrate the technical solutions of the embodiments of the present disclosure, a brief introduction will be given to the accompanying drawings required for the embodiments. It should be understood that the following drawings only illustrate certain embodiments of the present disclosure and therefore should not be regarded as limiting the scope. For those of ordinary skill in the art, other related drawings can also be obtained based on these drawings without making creative efforts.

FIG. 1 is a computerized tomography (CT) three-dimensional pore map of a cathode composite material after 100 cycles of a battery made of a solid electrolyte provided in Embodiment 1;

FIG. 2 is a CT three-dimensional pore map of a cathode composite material after 100 cycles of a battery made of a solid electrolyte provided in Comparative Embodiment 1;

FIG. 3 is a focused ion beam scanning electron microscope (FIB-SEM) image of a cathode composite material after 100 cycles of the battery made of the solid electrolyte provided in Embodiment 1; and YZr-Q refers to the sample in Embodiment 1, and LCO refers to the positive electrode active substance LiCoO₂.

FIG. 4 is a focused ion beam scanning electron microscope image of a cathode composite material after 100 cycles of the battery made of the solid electrolyte provided in Comparative Embodiment 1; and YZr—N refers to the sample in Comparative Embodiment 1, and LCO refers to the positive electrode active substance LiCoO₂.

### DETAILED DESCRIPTION OF THE EMBODIMENTS

In order to make the objectives, technical solutions, and advantages of the embodiments of the present disclosure clearer, the technical solutions in the embodiments of the present disclosure will be described clearly and completely hereinafter with reference to the accompanying drawings in the embodiments of the present disclosure. Apparently, the described embodiments are only a part rather than all of the embodiments of the present disclosure.

Therefore, the following detailed description of the embodiments of the present disclosure provided in the accompanying drawings is not intended to limit the scope of the present disclosure as claimed, but is merely representative of selected embodiments of the present disclosure.

It should be noted that, in the absence of conflict, the embodiments of the present disclosure and the features in the embodiments may be combined with each other.

The present disclosure provides a preparation method of a high Young's modulus solid electrolyte, including following steps:
S1: an electrolyte raw material was molten under dry and oxygen-free conditions, with a melting temperature of 405-700° C. and a melting time of 1-20 h;
S2: the molten liquid electrolyte was rapidly cooled into a solid block, with a cooling rate controlled at 600-1200° C./min; and
S3: the cooled solid block was ground into powder to prepare a high Young's modulus solid electrolyte.

According to the present disclosure, the electrolyte raw material was Li₂₊ₓMₓN₁₋ₓCl₆, where M was one or more of Y, Er, Yb, Ho, In, La, Sc, Tb, and Dy; N was one or two of Zr and Hf; and 0≤x≤1. For example, the electrolyte raw material might be Li_{2.5}Y_{0.5}Zr_{0.5}Cl₆, Li_{2.6}Y_{0.6}Hf_{0.4}Cl₆, Li₃YCl₆ or Li_{2.5}Yb_{0.5}Hf_{0.5}Cl₆.

### Embodiment 1

In Embodiment 1 of the present disclosure, a high Young's modulus solid electrolyte is prepared by the following method:
S1: Li_{2.5}Y_{0.5}Zr_{0.5}Cl₆ (YZr-Q) was molten under dry and oxygen-free conditions, with melting temperature of 405° C. and melting time of 20 h;
S2: the molten liquid electrolyte was rapidly cooled into a solid block, with a cooling rate controlled at 600° C./min; and
S3: the cooled solid block was ground into powder to prepare a high Young's modulus solid electrolyte.

### Embodiment 2

In Embodiment 2 of the present disclosure, a high Young's modulus solid electrolyte is prepared by the following method:
S1: Li_{2.5}Y_{0.5}Zr_{0.5}Cl₆ was molten under dry and oxygen-free conditions, with melting temperature of 600° C. and melting time of 10 h;
S2: the molten liquid electrolyte was rapidly cooled into a solid block, with a cooling rate controlled at 1000° C./min; and
S3: the cooled solid block was ground into powder to prepare a high Young's modulus solid electrolyte.

### Embodiment 3

In Embodiment 3 of the present disclosure, a high Young's modulus solid electrolyte is prepared by the following method:
S1: Li_{2.6}Y_{0.6}Hf_{0.4}Cl₆ was molten under dry and oxygen-free conditions, with melting temperature of 500° C. and melting time of 15 h;
S2: the molten liquid electrolyte was rapidly cooled into a solid block, with a cooling rate controlled at 800° C./min; and
S3: the cooled solid block was ground into powder to prepare a high Young's modulus solid electrolyte.

### Embodiment 4

In Embodiment 4 of the present disclosure, a high Young's modulus solid electrolyte is prepared by the following method:
S1: Li₃YCl₆ was molten under dry and oxygen-free conditions, with melting temperature of 700° C. and melting time of 1 h;
S2: the molten liquid electrolyte was rapidly cooled into a solid block, with a cooling rate controlled at 1200° C./min; and
S3: the cooled solid block was ground into powder to prepare a high Young's modulus solid electrolyte.

### Embodiment 5

In Embodiment 5 of the present disclosure, a high Young's modulus solid electrolyte is prepared by the following method:
S1: Li_{2.5}Yb_{0.5}Hf_{0.5}Cl₆ was molten under dry and oxygen-free conditions, with melting temperature of 550° C. and melting time of 8 h;
S2: the molten liquid electrolyte was rapidly cooled into a solid block, with a cooling rate controlled at 900° C./min; and
S3: the cooled solid block was ground into powder to prepare a high Young's modulus solid electrolyte.

### Comparative Embodiment 1

In Comparative Embodiment 1, a solid electrolyte is prepared by the following method:
S1: Li_{2.5}Y_{0.5}Zr_{0.5}Cl₆ (YZr—N) was molten under dry and oxygen-free conditions, with melting temperature of 405° C. and melting time of 20 h;
S2: the molten liquid electrolyte was naturally cooled into a solid block; and
S3: the cooled solid block was ground into powder to prepare a solid electrolyte.

### Comparative Embodiment 2

In Comparative Embodiment 2, a solid electrolyte is prepared by the following method:
S1: Li_{2.5}Yb_{0.5}Hf_{0.5}Cl₆ was molten under dry and oxygen-free conditions, with melting temperature of 550° C. and melting time of 8 h;
S2: the molten liquid electrolyte was naturally cooled into a solid block; and
S3: the cooled solid block was ground into powder to prepare a solid electrolyte.

The solid electrolytes prepared according to the methods of Embodiments 1 to 5, Comparative Embodiments 1 and 2 were tested for Young's modulus in sequence. The testing method was as follows: 150 mg of each of the solid electrolytes in a glove box was placed in a mold battery for tabletting to obtain a flaky sample, with a tabletting pressure of 400 MPa. Subsequently, the flaky sample was taken out and the mechanical curve of the sample was measured by an atomic force microscope, and its Young's modulus was analyzed according to the mechanical curve.

The test results are shown in Table 1:

TABLE 1

| No. | Young's modulus (GPa) |
|---|---|
| Embodiment 1 | 13 |
| Embodiment 2 | 16 |
| Embodiment 3 | 9 |
| Embodiment 4 | 12 |
| Embodiment 5 | 15 |
| Comparative | 5 |
| Embodiment 1 | |
| Comparative | 3 |
| Embodiment 2 | |

As can be seen from Table 1, the solid electrolyte made by rapid cooling has a higher Young's modulus. The solid electrolyte with higher Young's modulus is more difficult to deform under the same stress, and can keep good contact with a cathode material when the material expands in volume, thus being better in mechanical properties.

The present disclosure further provides a preparation method of an all-solid-state lithium battery, including following steps:
A1: A layered cathode material was mixed with a solid electrolyte in a mass ratio of 7:3, and then the resulting mixture was ground into powder to obtain a cathode powder.

LiCoO₂, NMC811 or the like might be selected as the layered cathode material. In this step, grinding might be performed for about 10 min.
A2: An appropriate amount of sulfide solid electrolyte was weighed and placed into a liner of a mold battery; a pressure of 100 MPa was applied for tabletting to obtain a first electrolyte layer; then, an appropriate amount of the high Young's modulus solid electrolyte was taken and evenly placed onto the side of the first electrolyte layer in the thickness direction; and a pressure of 150 MPa was applied for tabletting to obtain a second electrolyte layer.

In step A2, Li6PS5Cl might be used as the sulfide solid electrolyte. Of course, the sulfide solid electrolyte might also be replaced with an oxide solid electrolyte, a halide electrolyte, a nitride electrolyte, a polymer electrolyte, an organic electrolyte, or a combination thereof.

In step A2, the high Young's modulus solid electrolyte is selected from one of the high Young's modulus solid electrolytes prepared in Embodiments 1-5.

A3: The cathode powder was evenly placed on the side of the second electrolyte layer away from the first electrolyte layer, and a pressure of 350 MPa was applied for tabletting to obtain a positive electrode active material layer.

A4: A metal indium sheet was placed on the side of the first electrolyte layer away from the second electrolyte layer, and a pressure of 50 MPa was applied for tabletting to obtain a negative electrode active material layer.

A5: The liner was placed into the mold battery, and the mold battery was locked and sealed to make an all-solid-state lithium battery.

All-solid-state lithium batteries, labeled as 1 #, 2 #, 3 #, 4 #and 5 #, were respectively prepared by using the high Young's modulus solid electrolytes obtained in Embodiments 1-5 according to the method described above.

The high Young's modulus solid electrolyte used in the step A2 was separately replaced with the solid electrolytes obtained in Comparative Embodiments 1 and 2 to prepare all-solid-state lithium batteries, which were respectively labeled as 6 #and 7 #.

The performance tests were conducted on the all-solid-state lithium batteries 1 #7 #, respectively. The test items are as follows:

### (1) Ionic Conductivity Test

The ionic conductivity was measured by an AC impedance method of an electrochemical workstation. The measurement temperature was room temperature, the frequency range was 1 Hz to 7 MHz, and the constant voltage was 10 mV. Solid electrolyte (SE) powder was cold-pressed into pellets at a pressure of 300 MPa using a die with a diameter of 10 mm. The results are shown in Table 2.

TABLE 2

| | Ionic conductivity |
|---|---|
| No. | (mS cm⁻¹) |
| 1# | 1.65 |
| 2# | 1.69 |
| 3# | 0.4 |
| 4# | 1.42 |
| 5# | 1.45 |
| 6# | 1.65 |
| 7# | 1.42 |

The data in Table 2 show that the ion conductivity of the solid electrolyte provided by the present disclosure is high, and its ionic transmission performance will not be affected basically when the heat treatment mode of the material is changed without changing its chemical composition, which indicates that it is feasible to change the heat treatment method to regulate its mechanical properties.

### (2) Cycle Stability Test

Charge and discharge tests were conducted at a current density of 1000 microamperes and a rate of 1 C, with a cut-off voltage of 2.6-4.6 volts. The results are shown in Table 3.

TABLE 3

| No. | Capacity retention ratio |
|---|---|
| 1# | 78.37% |
| 2# | 80.20% |
| 3# | 30% |
| 4# | 60% |
| 5# | 65% |
| 6# | 23.7% |
| 7# | 20.13% |

It can be seen from Table 3 that electrolytes with high Young's modulus and high ionic conductivity have better cycling ability. This indicates that the high Young's modulus electrolytes can maintain mechanical stability in assembled batteries, effectively resist external deformation, and thus maintain good particle contact with cathode materials, ultimately exhibiting better electrochemical performance.

(3) After 100 Cycles of Batteries 1 #and 6 #, their Cathode Composite Materials Were Tested by Computerized Tomography (CT).

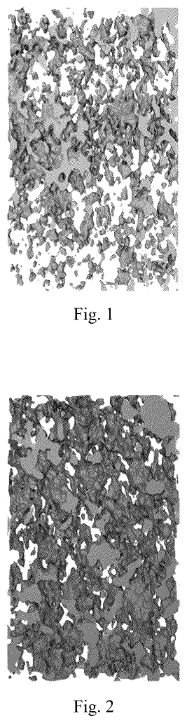

The CT images are shown in FIG. 1 (Embodiment 1) and FIG. 2 (Comparative Embodiment 1). It can be seen from the figure that the pores in the cathode composite material cube of Embodiment 1 are large and connected, indicating that the solid electrolyte has the rigidity to resist crack propagation and the toughness to withstand the cyclic stress applied by electrodes. The pores in the cathode composite material cube of Comparative Embodiment 1 are small and isolated, indicating that due to the application of undesirable stress, the solid electrolyte particles are crushed and pulverized, which results in the majority of the electrolyte samples shown in the slice.

### (4) After 100 Cycles of Batteries 1 #and 6 #, a Sample xx was Tested by a Focused Ion Beam Scanning Electron Microscope (FIB-SEM).

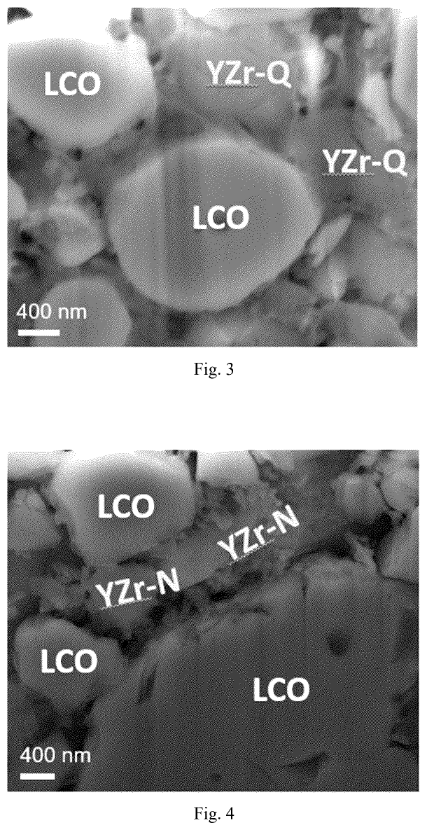

When the positive particles undergo volume expansion, the electrolyte shown in FIG. 3 (Embodiment 1) can effectively slow down the volume change caused by LiCoO₂ particles, thereby maintaining good physical contact between the electrolyte and the positive particles. On the contrary, significant pores appear between the positive particles and the electrolyte shown in FIG. 4 (Comparative Embodiment 1), and the electrolyte of Comparative Embodiment 1 is structurally pulverized, which ultimately leads to a physical contact failure between the positive particles and the electrolyte of Comparative Embodiment 1.

The above experimental results indicate that by controlling the cooling rates of the electrolytes, the mechanical properties of the electrolytes can be effectively changed. Under the same ion conductivity and transport performance, a high Young's modulus solid electrolyte not only balances chemical and electrochemical stability, but also is less prone to deformation. Furthermore, materials with higher toughness can absorb more energy before material particles break, and can better overcome volume changes and maintain the integrity of the particles when the positive particles expand in volume, thereby ensuring effective physical contact between the particles and giving a battery a long cycle life. In contrast, a low Young's modulus solid electrolyte is more likely to undergo volume deformation when positive material particles expand, and low toughness makes it more likely to cause structural fragmentation and collapse, ultimately resulting in short cycle life and poor stability of a battery.

The present disclosure is not limited to the above alternative embodiments. Any other embodiments derived by anyone under the inspiration of the present disclosure, and any technical solutions falling within the scope defined by the claims of the present disclosure shall fall within the protection scope of the present disclosure.

What is claimed is:

1. A preparation method of a high Young's modulus solid electrolyte, comprising following steps:
S1: melting an electrolyte raw material under dry and oxygen-free conditions, with a melting temperature of 405-700° C. and a melting time of 1-20 h;
S2: rapidly cooling the molten liquid electrolyte into a solid block, with a cooling rate controlled at 600-1200° C./min; and
S3: grinding the cooled solid block into powder to prepare the high Young's modulus solid electrolyte.

2. The preparation method of the high Young's modulus solid electrolyte according to claim 1, wherein in step S1, the melting temperature is 405° C. and the melting time is 20 h, or the melting temperature is 500° C. and the melting time is 15 h, or the melting temperature is 600° C. and the melting time is 10 h, or the melting temperature is 700° C. and the melting time is 1 h.

3. The preparation method of the high Young's modulus solid electrolyte according to claim 1, wherein in step S2, the cooling rate is 600° C./min, 800° C./min, 1000° C./min or 1200° C./min.

4. The preparation method of the high Young's modulus solid electrolyte according to claim 1, wherein the electrolyte raw material is Li₂₊ₓMₓN₁₋ₓCl₆, wherein M is one or more of Y, Er, Yb, Ho, In, La, Sc, Tb, and Dy; N is one or two of Zr and Hf; and 0≤x≤1.

5. The preparation method of the high Young's modulus solid electrolyte according to claim 4, wherein the electrolyte raw material is Li_{2.5}Y_{0.5}Zr_{0.5}Cl₆, Li_{2.6}Y_{0.6}Hf_{0.4}Cl₆, Li₃YCl₆ or Li_{2.5}Yb_{0.5}Hf_{0.5}Cl₆.

6. A high Young's modulus solid electrolyte, obtained by the preparation method of the solid electrolyte according to claim 1.

7. An all-solid-state lithium battery, comprising a positive electrode active material layer, a negative electrode active material layer, and the high Young's modulus solid electrolyte according to claim 6, wherein the high Young's modulus solid electrolyte is pressed into a block and is disposed between the positive electrode active material layer and the negative electrode active material layer.

8. A preparation method of the all-solid-state lithium battery according to claim 7, comprising following steps:
A1: mixing a layered cathode material with the high Young's modulus solid electrolyte in a mass ratio of 7:3, and then grinding the resulting mixture into powder to obtain a cathode powder;
A2: weighing an appropriate amount of sulfide solid electrolyte and placing the sulfide solid electrolyte into a liner of a mold battery; applying a pressure of 100 MPa for tabletting to obtain a first electrolyte layer; then, taking an appropriate amount of the high Young's modulus solid electrolyte and evenly placing the high Young's modulus solid electrolyte onto the side of the first electrolyte layer in a thickness direction; applying a pressure of 150 MPa for tabletting to obtain a second electrolyte layer;
A3: placing the cathode powder evenly on the side of the second electrolyte layer away from the first electrolyte layer, and applying a pressure of 350 MPa for tabletting to obtain a positive electrode active material layer;
A4: placing a metal indium sheet on the side of the first electrolyte layer away from the second electrolyte layer, and applying a pressure of 50 MPa for tabletting to obtain a negative electrode active material layer; and
A5: placing the liner into the mold battery, locking and sealing to make an all-solid-state lithium battery.
